(19) United States
(12) Patent Application Publication
(10) Pub. No.: US 2021/0361397 A1
(43) Pub. Date: Nov. 25, 2021

(54) ORAL APPLIANCE

(71) Applicant: Junko FUJIKURA, Kanagawa (JP)

(72) Inventor: Junko FUJIKURA, Kanagawa (JP)

(21) Appl. No.: 17/319,754

(22) Filed: May 13, 2021

(30) Foreign Application Priority Data
May 22, 2020 (JP) 2020-089893

(51) Int. Cl. A61C 13/225; A44C 15/00

(52) U.S. Cl. CPC A61C 13/225; A44C 15/0005

(57) ABSTRACT

A plate-shaped body portion curved in a thickness direction and having a back surface that abuts on a gum portion during the wearing is provided. The body portion has a thickness that is thick at a position where a first recessed portion to avoid an upper lip frenulum is provided or a portion adjacent to the first recessed portion and thins toward an end.

This application claims the benefit of priority to Japanese Patent Application Number 2020-089893 filed on May 22, 2020. The entire contents of the above-identified application are hereby incorporated by reference.

### BACKGROUND

### Technical Field

The present invention relates to an oral appliance.

Patent Document 1 discloses cosmetic teeth provided with decorative teeth for decorating a surface of decorated teeth and a decorative gingiva adhered to a surface of a gingiva at the root of the decorated teeth.

### CITATION LIST

### Patent Literature

Patent Document 1: JP 2014-23827 A

In the technology described in Patent Document 1, to wear the cosmetic teeth, a back surface of the decorative gingiva needs to be adhered to the surface of the gingiva at the root of the decorated teeth of a user, causing a problem that mounting/removal cannot be easily performed.

### SUMMARY

One or more embodiments of the present invention are directed to an oral appliance that is less likely to cause position deviation during wearing and allows obtaining a good fit while mounting/removal are easy.

An oral appliance according to one or more embodiments of the present invention may be worn on a front surface of a gum portion of a maxilla. The oral appliance includes a plate-shaped (substantially plate-like) body portion, a first recessed portion, and a plurality of second recessed portions and a plurality of projection portions. The body portion is curved in a thickness direction. The body portion has a back surface that abuts on the gum portion during the wearing. The first recessed portion to avoid an upper lip frenulum is provided at a substantially center on an upper side in a height direction of the body portion. The plurality of second recessed portions and the plurality of projection portions are provided on a lower side in the height direction of the body portion. The second recessed portion has a peripheral edge with a substantially arc shape. The projection portion with a pointed distal end is provided between the adjacent second recessed portions. The projection portion is disposed in an interdental papilla during the wearing. The body portion has a thickness that is thick at a position where the first recessed portion is provided or a portion adjacent to the first recessed portion and that thins toward an end.

The oral appliance according to one or more embodiments of the present invention includes the substantially plate-like body portion curved in the thickness direction and having the back surface that abuts on the gum portion during the wearing. The body portion has the thickness that is thick at the position where the first recessed portion to avoid the upper lip frenulum is provided or the portion adjacent to the first recessed portion and that thins toward the end. Since the thickness of the body portion is thin, deformation of the body portion is easy, and thus the oral appliance can be easily mounted and removed. In addition, since the body portion curves in the thickness direction and the back surface of the body portion abuts on the gum portion during the wearing, the oral appliance can be worn without using an adhesive. Moreover, position deviation is less likely to occur during the wearing in which the back surface abuts on the gum portion, and a good fit can be obtained.

Here, the body portion may be thick in the position where the first recessed portion is provided or the portion adjacent to the first recessed portion and both ends and may thin from the first recessed portion or the portion adjacent to the first recessed portion toward the end and from both the ends toward the center. As a result, strength of the body portion increases and the body portion is less likely to deform, and therefore the position deviation is less likely to occur while the oral appliance is worn.

Here, a stopper that protrudes in an oral direction during the wearing may be provided at a distal end portion on a back surface of the projection portion. When the stopper is viewed in a direction substantially orthogonal to the back surface of the body portion, the stopper may have a substantially quadrangular shape or a substantially triangular shape with a bottom side disposed on an upper side. Thus, the stopper is disposed between a tooth and a tooth at a tip of the interdental papilla, and the position deviation is less likely to occur while the oral appliance is worn.

Here, a wall thickness at a thickest portion of the stopper may be (approximately) twice or more of a wall thickness at a root of the stopper. Thus, when the interdental papilla disappears and a triangular gap is formed at the root portion between a tooth and a tooth, the stopper can be inserted into the gap, and therefore the position deviation is less likely to occur during the wearing and a good fit can be obtained.

Here, a protruding portion protruding upward may be provided in a vicinity of an end of the body portion on an upper side in the height direction of the body portion. Accordingly, when the oral appliance is worn, inserting the protruding portions between the maxilla and an upper lip allows reducing the position deviation and a drop of the oral appliance.

According to one or more embodiments of the present invention, while mounting/removal are easy, position deviation is less likely to occur during mounting and a good fit can be obtained.

### BRIEF DESCRIPTION OF DRAWINGS

FIG. 1 is a perspective view illustrating an outline of an oral appliance 1 and is a diagram viewed from an oblique front side.

FIG. 2 is a perspective view illustrating the outline of the oral appliance 1 and is a diagram viewed from an oblique rear side.

FIG. 3 is a front view illustrating the outline of the oral appliance 1.

FIG. 4 is a rear view illustrating the outline of the oral appliance 1.

FIG. 5 is a cross-sectional view taken along line A-A in FIG. 4.

FIG. 6 is a cross-sectional view taken along line B-B in FIG. 4.

FIG. 7 is a perspective view illustrating an outline of an oral appliance 2.

FIG. 8 is a front view illustrating an outline of an oral appliance 3.

FIG. 9 is a side view illustrating the outline of the oral appliance 3.

### DESCRIPTION OF EMBODIMENTS

Hereinafter, embodiments of the present invention will be described in detail with reference to the drawings. An oral appliance of the present invention is worn on a front surface of a gum portion in a maxilla of a user for use.

### First Embodiment

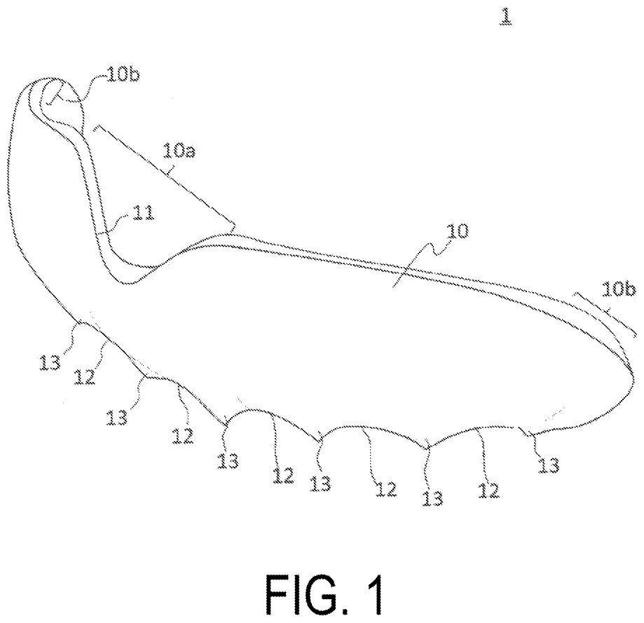

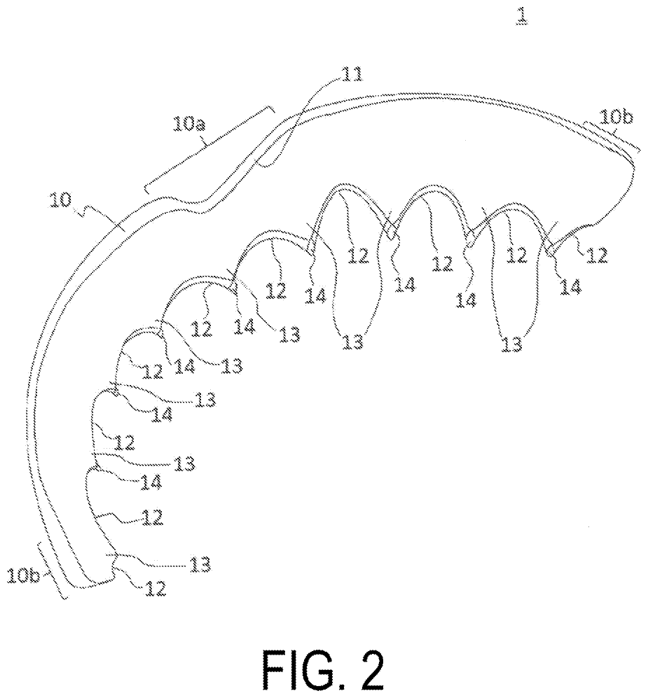

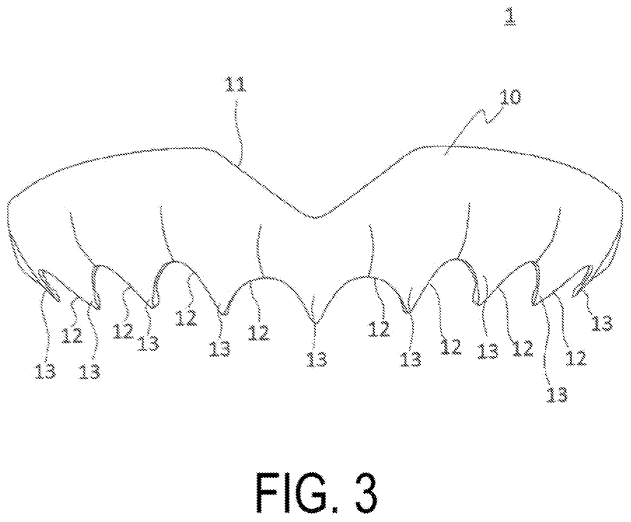

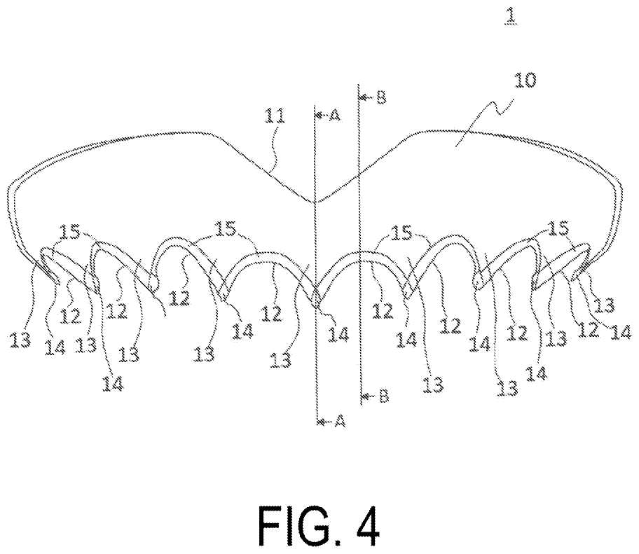

FIG. 1 is a perspective view illustrating an outline of an oral appliance 1 and is a diagram viewed from an oblique front side. FIG. 2 is a perspective view illustrating the outline of the oral appliance 1 and is a diagram viewed from an oblique rear side. FIG. 3 is a front view illustrating the outline of the oral appliance 1. FIG. 4 is a rear view illustrating the outline of the oral appliance 1.

Hereinafter, a side located on a front surface while the oral appliance 1 is worn (diagonally forward left in the paper of FIG. 1) is referred to as a front surface of the oral appliance 1, and a side located on the user side while the oral appliance 1 is worn (the right far-side in the paper of FIG. 1) is referred to as a back surface of the oral appliance 1. Additionally, a side located on an upper lip side of the user during wearing (the upper side of FIGS. 3 and 4) is referred to as an upper side of the oral appliance 1, and a side located on a lower lip side of the user during wearing (the lower side of FIGS. 3 and 4) is referred to as a lower side of the oral appliance 1.

The oral appliance 1 includes a body portion 10. The body portion 10 is a substantially plate-like member curved in a thickness direction and is formed by curving a resin. The body portion 10 is curved along a curvature of a gum portion of the user, and when the oral appliance 1 is worn, a back surface of the body portion 10 abuts on the gum portion of the user.

The body portion 10 is formed using a gingiva-colored resin.

Furthermore, a hard resin, such as a polyamide resin, a polycarbonate resin, or an acrylic resin, can be used as the resin.

While the oral appliance 1 is worn, since a longitudinal direction of the body portion 10 extends in a lateral direction of the user, the longitudinal direction of the body portion 10 is referred to as the lateral direction of the body portion 10. Additionally, a direction substantially orthogonal to the lateral direction of the body portion 10 viewed from the front surface is referred to as a height direction of the body portion 10.

A first recessed portion 11 is provided at the substantially center on the upper side in the height direction of the body portion 10 to avoid an upper lip frenulum. The first recessed portion 11 has a substantially V-shape when viewed from the front surface. The first recessed portion 11 provided at the substantially center of the body portion 10 facilitates lateral alignment of the oral appliance 1 with the gum portion of a wearer. However, a size (a depth and a width) of the first recessed portion 11 is not limited to the illustrated embodiment configuration.

The thickness of the body portion 10 is thick in a region where the first recessed portion 11 is provided (hereinafter referred to as a region 10a) and in both end portions (hereinafter referred to as a region 10b), and is thin in a region between the region 10a and the region 10b. In other words, the thickness of the body portion 10 thins from the first recessed portion 11 toward the end and from both ends toward the center. By thinning the thickness between the region 10a and the region 10b, the body portion 10 easily deforms and the oral appliance 1 can be easily mounted and removed. In addition, an uncomfortable feeling is less likely to be felt during wearing and a good fit can be obtained.

Note that the region 10a may include a region in the vicinity of the first recessed portion 11, in addition to the region where the first recessed portion 11 is provided. Additionally, the region 10b may include regions in the vicinity of both ends, in addition to both ends of the body portion 10.

In addition, in the region 10a, the thickness of the position where the first recessed portion 11 is provided may be thinned, and the thickness of the portion adjacent to the first recessed portion 11 may be thickened. By thinning the thickness of the position where the first recessed portion 11 is provided, an uncomfortable feeling is less likely to be felt during wearing.

A plurality of second recessed portions 12 and a plurality of projection portions 13 are provided on the lower side in the height direction of the body portion 10. The second recessed portions 12 have peripheral edges with a substantially arc shape to expose the user's teeth. The projection portion 13 is provided between the adjacent second recessed portions 12 and disposed in an interdental papilla of the user during wearing. The projection portion 13 has a substantially V-shape or a substantially U-shape in front view, and has a pointed tip.

Note that, in FIGS. 3 and 4, the 10 second recessed portions 12 are provided and the nine projection portions 13 are provided, but the numbers of the second recessed portions 12 and the projection portions 13 are not limited to these. However, to cover at least portions equivalent to central incisors, lateral incisors, and canine teeth by the oral appliance 1, providing eight or more of the second recessed portions 12 and providing seven or more of the projection portions 13 are desirable. A size (a depth and a width) of the second recessed portion 12 and a size (a height and a width) of the projection portion 13 are not limited to the illustrated configurations.

As illustrated in FIG. 4, stoppers 14 that protrude in an oral direction during wearing are provided at distal end portions on back surfaces of the projection portions 13. When viewed in a direction substantially orthogonal to the back surface of the body portion 10, the stopper 14 has a substantially quadrangular shape. Configuring the stopper 14 having the substantially quadrangular shape allows the stopper 14 to be disposed between a tooth and a tooth at the tip of the interdental papilla. Note that the substantially quadrangular shape includes a shape in which arcs are formed at the corners.

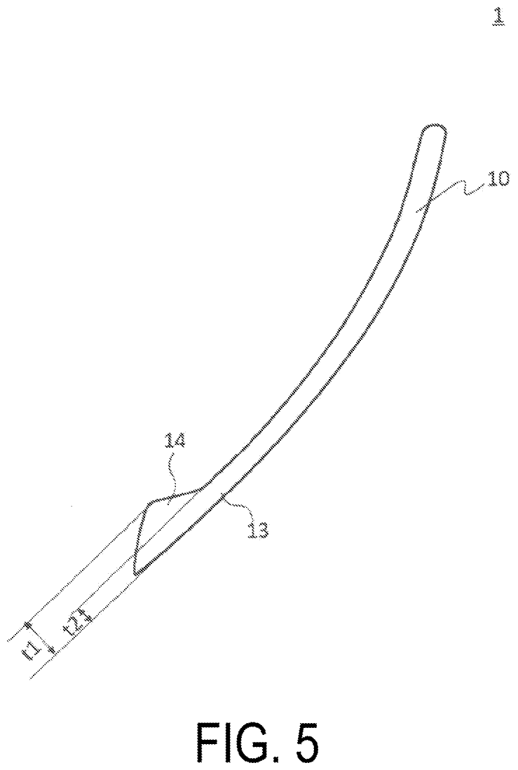

FIG. 5 is a cross-sectional view taken along line A-A in FIG. 4. A wall thickness t1 at the thickest portion of the stopper 14 is (approximately) twice or more of a wall thickness t2 at a root of the stopper 14. When the interdental papilla disappears, a triangular gap is formed at the root portion between a tooth and a tooth. The portion of the stopper 14 having the thick wall thickness can be inserted into the gap, and therefore position deviation is less likely to occur during wearing and a good fit can be obtained.

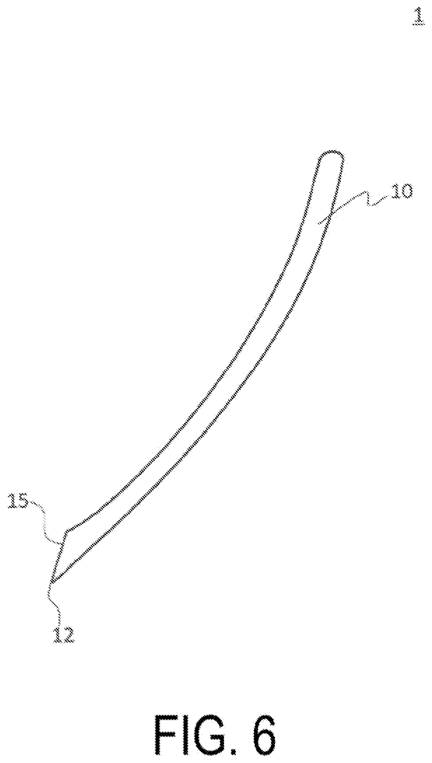

FIG. 6 is a cross-sectional view taken along line B-B in FIG. 4. The second recessed portion 12 has a thin wall thickness portion 15 having a thickness that thins toward the distal end. This allows the thin wall thickness portions 15 to cover the root portions of the user's teeth and improving aesthetics during wearing.

According to the present embodiment, the body portion 10 has the substantially plate-like shape curved in the thickness direction, and substantially the entire back surface of the body portion 10 is brought into abutment with the front surface of the gum portion in the maxilla. Accordingly, the oral appliance 1 can be worn without using an adhesive and position deviation is less likely to occur while the oral appliance 1 is worn. In addition, by thinning the thickness between the region 10a and the region 10b, an uncomfortable feeling is less likely to be felt and a good fit can be obtained during wearing.

In addition, according to the present embodiment, by thinning the thickness between the region 10a and the region 10b, the body portion 10 easily deforms and mounting/removal are easy. By thickening the thickness of the region 10a, the body portion 10 easily deforms and strength of the body portion 10 can be increased. In addition, since the strength of the body portion 10 increases and the body portion 10 is less likely to deform by thickening the thickness of the region 10b, position deviation is less likely to occur while the oral appliance 1 is worn.

According to the present embodiment, the oral appliance 1 covers only the gingiva portion, and thus the oral appliance 1 can be downsized and the manufacturing is easy. For example, when the oral appliance includes decorative teeth and a decorative gingiva, it is necessary to make colors and materials different between the decorative teeth and the decorative gingiva, which takes a labor in manufacturing. Also, because the oral appliance includes the decorative teeth, the oral appliance 1 increases in size. In contrast, since the oral appliance 1 of the present embodiment does not include decorative teeth, the body portion 10 is formed by only one resin, and therefore the manufacturing is easy. Further, in the case where the oral appliance includes the decorative teeth, a fault possibly occurs during eating or drinking. In contrast, since the oral appliance 1 of the present embodiment does not include decorative teeth, a fault, such as adherence of food or drink between the teeth of the user and the decorative teeth during eating or drinking, does not occur, and therefore the oral appliance 1 features good usability.

Note that in the present embodiment, the stoppers 14 are provided at the distal end portions on the back surfaces of the projection portions 13, but the stoppers 14 are not essential.

In addition, in the present embodiment, when viewed in the direction substantially orthogonal to the back surface of the body portion 10, the stopper 14 has the substantially quadrangular shape, but the shape of the stopper 14 is not limited this. For example, when viewed in the direction substantially orthogonal to the back surface of the body portion 10, the stopper 14 may have a substantially triangular shape with the bottom side disposed on the upper side. In this case as well, the stopper 14 can be disposed between a tooth and a tooth at the tip of the interdental papilla. Note that the substantially triangular shape includes a shape in which arcs are formed at the corners, and includes a shape in which the bottom side has a curved portion.

### Second Embodiment

In the first embodiment, the thicknesses of the region 10a, both ends, and the region 10b are thickened and the thickness between the region 10a and the region 10b is thinned, but the configuration of the body portion is not limited to this.

The second embodiment has a configuration in which only the region 10a is thick. Description of an oral appliance 2 according to the second embodiment will be given in detail. Note that the same portions as those in the first embodiment are denoted by the same reference numerals, and detailed descriptions thereof will be omitted in the second embodiment.

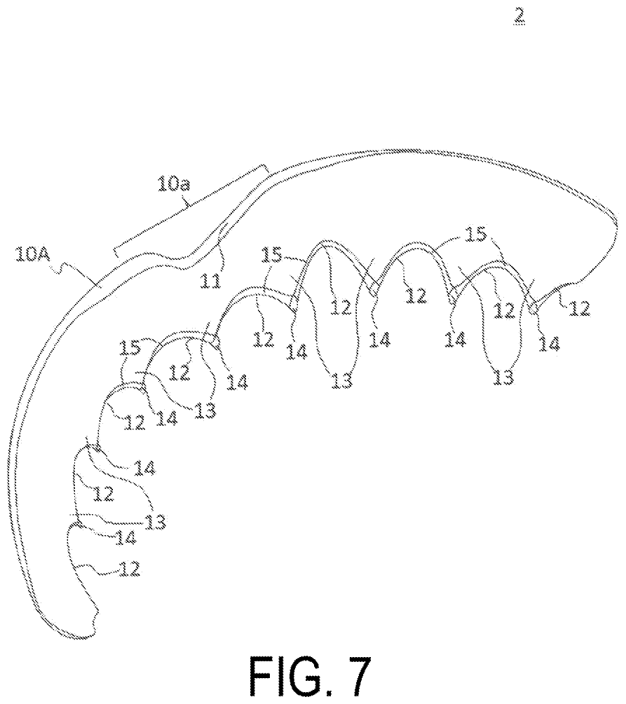

FIG. 7 is a perspective view illustrating an outline of the oral appliance 2. The oral appliance 2 includes a body portion 10A. Similarly to the body portion 10, the body portion 10A has a substantially plate-like shape curved in a thickness direction and is formed by curving a hard resin. By curving the body portion 10A along the curvature of the gum portion of the user, when the oral appliance 2 is worn, a back surface of the body portion 10A abuts on the gum portion.

The first recessed portion 11 is provided at the substantially center on the upper side of the body portion 10A. The plurality of second recessed portions 12 and the plurality of projection portions 13 are provided on the lower side of the body portion 10A.

The thickness of the body portion 10A is thick in the region 10a, and is thin at a portion other than the region 10a. The thickness of the body portion 10A thins from the first recessed portion 11 toward the end.

According to this embodiment, by thickening the thickness of only the region 10a and thinning the thickness other than the region 10a, an uncomfortable feeling is less likely to be felt and a good fit can be obtained while the oral appliance 2 is worn. Especially, by thinning the thicknesses of both end portions of the body portion 10A, the effect that an uncomfortable feeling is less likely to be felt while the oral appliance 2 is worn becomes great.

### Third Embodiment

In the first embodiment, the height of the body portion 10 is substantially constant, but the configuration of the body portion is not limited to this.

The third embodiment has a configuration in which protruding portions are provided in the vicinity of both ends of a body portion. Hereinafter, a description of an oral appliance 3 according to the third embodiment will be given in detail. Note that the same portions as those in the first embodiment are denoted by the same reference numerals, and detailed descriptions thereof will be omitted in the third embodiment.

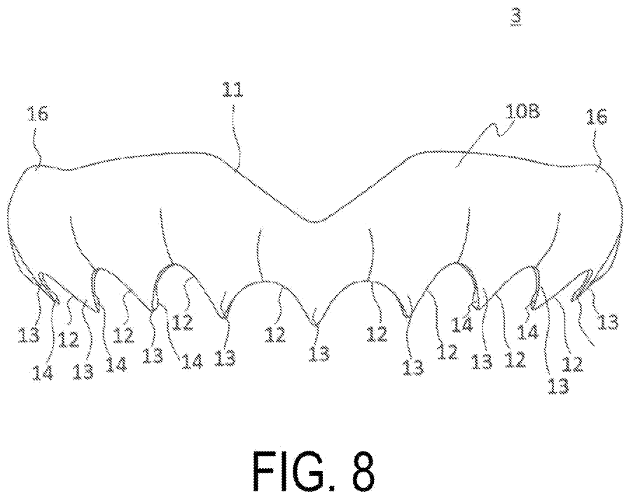

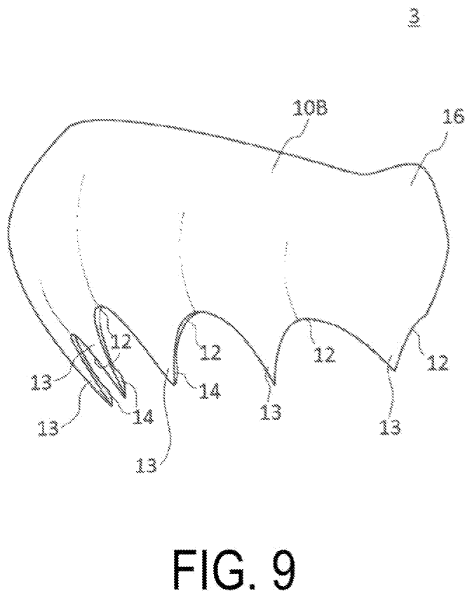

FIG. 8 is a front view illustrating an outline of the oral appliance 3. FIG. 9 is a side view illustrating the outline of the oral appliance 3. The oral appliance 3 includes a body portion 10B. Similarly to the body portion 10, the body portion 10B has a substantially plate-like shape curved in a thickness direction and is formed by curving a hard resin. By curving the body portion 10B along the curvature of the gum portion of the user, when the oral appliance 2 is worn, a back surface of the body portion 10B abuts on the gum portion.

The first recessed portion 11 is provided at the substantially center on the upper side in the height direction of the body portion 10B. The plurality of second recessed portions 12 and the plurality of projection portions 13 are provided on the lower side in the height direction of the body portion 10B.

The thickness of the body portion 10B is thick in the region 10a, and is thin at a portion other than the region 10a. The thickness of the body portion 10B thins from the first recessed portion 11 toward the end.

Protruding portions 16 protruding upward are provided in the vicinity of ends of the body portion 10B on the upper side in the height direction of the body portion 10B. The protruding portions 16 may be provided on both ends of the body portion 10B or may be provided on only one end of the body portion 10B.

According to this embodiment, while the oral appliance 3 is worn, inserting the protruding portions 16 between the maxilla and the upper lip allows reducing position deviation and a drop of the oral appliance 3. Additionally, by providing the protruding portions 16, the thickness of the body portion 10B other than the region 10a is thinned further, and an uncomfortable feeling is less likely to be felt while the oral appliance 3 is worn.

The embodiments of the invention are described above in detail with reference to the drawings. However, specific configurations are not limited to the embodiments and also include changes in design or the like without departing from the gist of the invention. For example, in the examples described above, detailed description is made to facilitate understanding of the present invention, and the examples are not necessarily limited to examples including all the configurations described above.

In addition, the configuration of an embodiment can be replaced partially with the configurations of other embodiments. In addition, addition, deletion, replacement or the like of other configurations can be made on the configurations of the embodiments.

Additionally, in the present disclosure, “substantially” is a concept not only including the case of being strictly the same, but also including an error and deformation to the extent that a loss of identity does not occur. For example, “substantially parallel” and “substantially orthogonal” are not limited to the cases of being strictly parallel and orthogonal, and are concepts to the extent of not losing uniformity, for example, including an error of several degrees. In addition, “vicinity” in the present disclosure means a concept in which, for example, a place in the vicinity of A is close to A and may include or need not include A.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

### REFERENCE SIGNS LIST

1, 2, 3: Oral appliance
10, 10A, 10B: Body portion
10a, 10b Region
11: First recessed portion
12: Second recessed portion
13: Protrusion portion
14: Stopper
15: Wall thickness portion
16: Protrusion portion

1. An oral appliance to be worn on a front surface of a gum portion of a maxilla, the oral appliance comprising
a plate-shaped body portion curved in a thickness direction, the body portion having a back surface that abuts on the gum portion during the wearing;
a first recessed portion to avoid an upper lip frenulum provided at a center on an upper side in a height direction of the body portion; and
a plurality of second recessed portions and a plurality of projection portions provided on a lower side in the height direction of the body portion, the second recessed portion having a peripheral edge with an arc shape, the projection portion with a pointed distal end being provided between the adjacent second recessed portions, the projection portion being disposed in an interdental papilla during the wearing,
wherein a thickness of the body portion decreases from a position where the first recessed portion is provided or a portion adjacent to the first recessed portion toward an end.

2. An oral appliance to be worn on a front surface of a gum portion of a maxilla, the oral appliance comprising
a plate-shaped body portion curved in a thickness direction, the body portion having a back surface that abuts on the gum portion during the wearing;
a first recessed portion to avoid an upper lip frenulum provided at a center on an upper side in a height direction of the body portion; and
a plurality of second recessed portions and a plurality of projection portions provided on a lower side in the height direction of the body portion, the second recessed portion having a peripheral edge with a arc shape, the projection portion with a pointed distal end being provided between the adjacent second recessed portions, the projection portion being disposed in an interdental papilla during the wearing,
wherein
the thickness of the body portion decreases from both the ends toward the center.

3. The oral appliance according to claim 1, wherein
a stopper that protrudes in an oral direction during the wearing is provided at a distal end portion on a back surface of the projection portion, and
when the stopper is viewed in a direction orthogonal to the back surface of the body portion, the stopper has a quadrangular shape or a triangular shape with a bottom side disposed on an upper side.

4. The oral appliance according to claim 3, wherein
a wall thickness at a thickest portion of the stopper is twice or more of a wall thickness at a root of the stopper.

5. The oral appliance according to claim 1, wherein
a protruding portion protruding upward is provided in a vicinity of an end of the body portion on an upper side in the height direction of the body portion.

6. The oral appliance according to claim 2, wherein
a stopper that protrudes in an oral direction during the wearing is provided at a distal end portion on a back surface of the projection portion, and
when the stopper is viewed in a direction orthogonal to the back surface of the body portion, the stopper has a quadrangular shape or a triangular shape with a bottom side disposed on an upper side.

7. The oral appliance according to claim 2, wherein
a protruding portion protruding upward is provided in a vicinity of an end of the body portion on an upper side in the height direction of the body portion.

8. The oral appliance according to claim 3, wherein
a protruding portion protruding upward is provided in a vicinity of an end of the body portion on an upper side in the height direction of the body portion.

9. The oral appliance according to claim 4, wherein
a protruding portion protruding upward is provided in a vicinity of an end of the body portion on an upper side in the height direction of the body portion.
